(19) United States
(12) Patent Application Publication
(10) Pub. No.: US 2026/0350696 A1
(43) Pub. Date: Nov. 5, 2026

(54) Multi-Asset Class Risk Assessment System for Predictive Risk Modeling in Luxury and Alternative Asset Lending

(71) Applicant: Toral K Mehta, Watchung, NJ (US)

(72) Inventor: Toral K Mehta, Watchung, NJ (US)

(21) Appl. No.: 19/199,131

(22) Filed: May 5, 2025

(51) Int. Cl. G06Q 40/03; G06Q 40/06

(52) U.S. Cl. CPC G06Q 40/03; G06Q 40/06

(57) ABSTRACT

A computer-implemented system and method for comprehensive risk assessment across multiple asset classes, including luxury goods, fine art, classic automobiles, watches, and collectibles. The system integrates AI-driven asset valuations and market trend analytics to generate dynamic, predictive risk scores. Utilizing machine learning models trained on historical loan performance and asset volatility, the system provides lenders with holistic risk evaluation that adapts continuously to market changes and asset-specific factors, enhancing credit decision accuracy and portfolio management.

### BACKGROUND

Current risk assessment approaches often focus on single asset classes or rely heavily on traditional credit scoring, lacking sensitivity to the unique risk profiles of diverse luxury and alternative assets. There exists a need for a unified, multi-asset class risk modeling system that considers asset-specific characteristics and market dynamics to predict default risk and optimize lending strategies.

### SUMMARY

The invention offers a multi-asset risk assessment platform that combines AI-based asset valuation inputs with market indicators and macroeconomic data. Machine learning algorithms analyze cross-asset correlations, historical default patterns, and market volatility to generate dynamic risk scores. The system supports real-time updates, enabling lenders to adjust credit terms proactively. Key features include comprehensive asset evaluation modules, predictive risk scoring engines, and integration with loan management and blockchain provenance systems.

### BRIEF DESCRIPTION OF THE DRAWINGS

FIG. 1 illustrates the system architecture of the multi-asset class risk assessment system.

FIG. 2 depicts the workflow of the risk assessment process, including data collection, machine learning modeling, risk score generation, dynamic updates, risk reporting, and feedback loops.

FIG. 3 shows a flowchart of the credit line adjustment algorithm, including triggers, recalculation, notifications, and blockchain event logging.

FIG. 4 depicts blockchain integration with smart contract interactions for credit limit recording, transaction freezing, and audit log writing.

### DETAILED DESCRIPTION OF THE INVENTION

### Overview

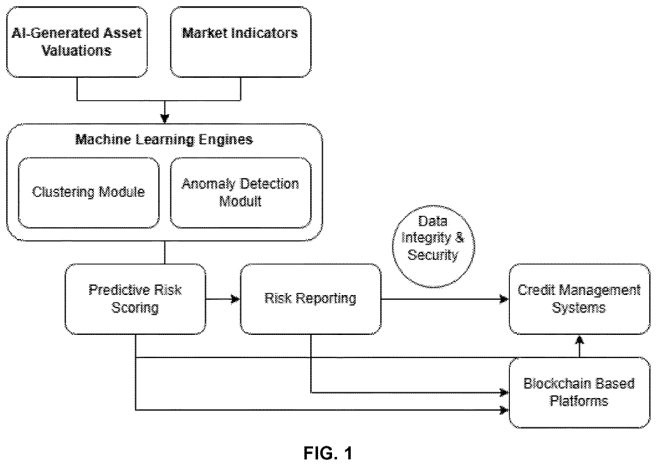

Referring to FIG. 1, a system 100 for multi-asset class risk assessment and dynamic credit line management comprises interconnected modules including data ingestion, AI-based asset valuation, market indicator analysis, data aggregation, machine learning risk modeling, credit line adjustment algorithms, reporting, and integration with blockchain-based provenance and compliance platforms.

### System Architecture (FIG. 1)

### System 100 Includes the Following Components

AI-Generated Asset Valuation Engine 102: Receives and processes digital asset data, including high-resolution images (JPEG, PNG), structured metadata (JSON, XML), provenance documentation (PDF), and optionally IoT sensor data. For example, a classic car submission may include VIN, make, model, year, maintenance records, and GPS-enabled storage sensor data.
Market Indicator Module 104: Pulls real-time and historical market data, such as asset-class volatility, liquidity indices, comparable sales, and macroeconomic indicators, from third-party APIs or internal databases, typically as JSON or CSV time series.
Data Aggregation and Preprocessing Module 106: Normalizes input data, assigns unique asset identifiers (UUID), standardizes currency to USD, performs outlier removal using Hampel filters, and applies KNN-based imputation to fill missing values.
Machine Learning Engine 108: Hosts multiple predictive submodules:
   Clustering Submodule 110: Applies unsupervised learning (k-means, DBSCAN) to group assets by volatility, liquidity, and historical performance.
   Anomaly Detection Submodule 112: Employs isolation forests and autoencoders to flag unusual asset or transaction behaviors.
   Reinforcement Learning Submodule 114: Continuously tunes feature weights and policy parameters to optimize default prediction accuracy, using agent rewards based on loan performance outcomes.
Risk Scoring Module 116: Aggregates outputs from submodules 110, 112, and 114, producing a composite risk score (normalized 0 to 1) for each asset or asset bundle.
Credit Line Adjustment Module (CLA) 130: Dynamically calculates and updates user credit lines based on real-time asset values, risk scores, and policy constraints (described in detail below).
Risk Reporting Module 118: Provides dashboards, alerts, and formatted reports (CSV, PDF, JSON) for lenders and compliance officers.
Integration Interfaces 120: API endpoints for external credit management systems; blockchain connectors for on-chain lien and event recording; authentication and access control (OAuth2).

### Data Ingestion and Asset Valuation

The AI-Generated Asset Valuation Engine 102 ingests input data through a web portal, mobile app, or API. For image data, a convolutional neural network (CNN, e.g., ResNet) extracts features such as asset condition and authenticity markers. For text and document data, OCR and NLP (e.g., BERT) models parse and structure provenance information. A gradient-boosted decision tree (e.g., XGBoost) combines these features with market comparables to produce an estimated value V, a confidence score, and a provenance risk flag. All asset data is stored with a UUID for traceability.

### Market Indicator Analysis

Market Indicator Module 104 retrieves data from sources such as Bloomberg, Nasdaq Data Link, auction house feeds, and proprietary indices. Indicators include volatility (standard deviation of price changes), liquidity (average days to sale), and macroeconomic factors (inflation, interest rates). Sentiment analysis may be performed on news/social feeds using LSTM or transformer-based NLP models to generate a real-time market sentiment score.

### Data Aggregation and Preprocessing

Module 106 merges asset and market data, ensuring consistency and completeness.

Schema validation is enforced (e.g., via JSON Schema). Outlier removal is performed using Hampel filters; missing values are imputed by KNN. All currency values are converted to a system-standard (e.g., USD) using current exchange rates. Preprocessed records are passed to the machine learning engine.

### Machine Learning Risk Modeling

### Machine Learning Engine 108 Includes

Clustering Submodule 110: Performs k-means clustering on asset features (volatility, liquidity, value, sentiment) to assign each asset to a risk tier.
Anomaly Detection Submodule 112: Detects outliers by applying isolation forests (scikit-learn) and autoencoder networks trained to reconstruct “normal” asset patterns.
Reinforcement Learning Submodule 114: Implements a DON agent that adjusts LTV ratios and risk feature weights. The agent's reward is inversely proportional to prediction error on historical loan outcomes, updated with loan performance feedback.

All models are deployed as microservices (Docker), communicating via REST APIs and message queues (RabbitMQ). Model metadata and performance are tracked for auditability.

### Risk Scoring and Reporting

Risk Scoring Module 116 computes a composite risk score for each asset or group, using an ensemble approach that weights outputs from clustering, anomaly detection, and reinforcement learning. Scores are recalculated with each new data input or market event. Risk Reporting Module 118 presents this data via a React. js dashboard, with options for export and alert configuration.

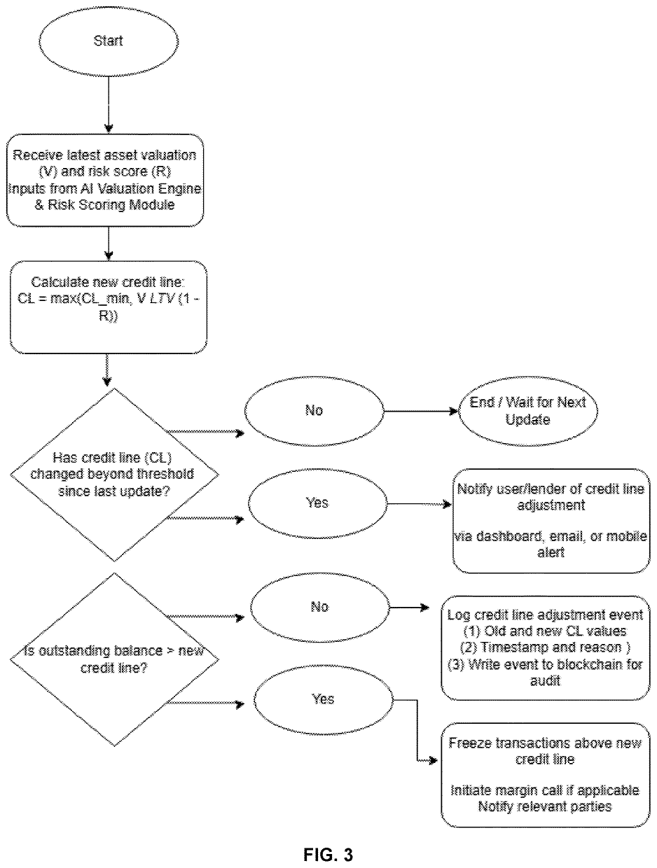

### Credit Line Adjustment Module and Algorithm (FIG. 3)

The Credit Line Adjustment (CLA) module 130 manages credit line determination and real-time adjustment:
Initial Determination:

CLO=V LTV (1−R)

Where V=verified asset value, LTV=loan-to-value ratio, R=normalized risk score.
Continuous Adjustment:

CL(t)=max(CL_min, V(t) LTV (1−R(t)))

CL_min=minimum allowable credit line.
Triggers:
   Asset devaluation>threshold
   Adverse market event or flagged anomaly
   Manual override (policy-controlled)
Actions:
   User notification
   Transaction freeze above new credit line
   Margin call initiation if credit line<outstanding balance
AI-Optimized Policy:

Reinforcement learning agent adjusts LTV and risk weightings over time.

Sample pseudocode is included for illustration.

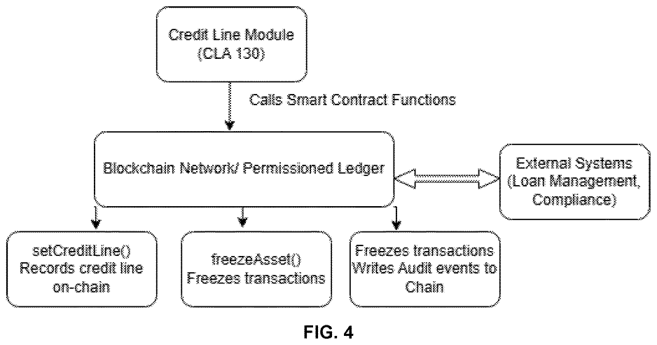

Integration Interfaces and Blockchain Provenance (FIG. 4) Integration Interfaces 120 connect system 100 to external loan management platforms and blockchain provenance systems.
Credit Management API exposes RESTful endpoints secured by OAuth2.
Blockchain integration records credit line adjustments, liens, and transaction freezes on a permissioned distributed ledger (e.g., Hyperledger Fabric or private Ethereum).

Smart contracts provide functions setCreditLine, freezeAsset, and logAdjustment to enforce and log credit line policies immutably.

### Security and Data Integrity

All communications use TLS 1.3; data at rest is AES-256 encrypted. API requests are HMAC signed. Role-based access control is enforced.

### Example Use Case

A lender underwrites a loan secured by vintage guitars. Asset data and provenance are submitted and valued. Market data is retrieved. Risk scores are generated, and CLA calculates credit lines. Real-time updates trigger credit line adjustments and notifications. All events are auditable on-chain.

### Best Mode

Preferred deployment uses AWS, Docker Swarm, TensorFlow, XGBoost, and Hyperledger Fabric. APIs use OpenAPI with CI/CD via GitHub Actions.

### Alternative Embodiments

Real-time video or IoT for asset monitoring
Federated learning for privacy-preserving model updates
Public blockchain with zk-SNARK privacy

### Use Cases

Lenders evaluating credit risk for portfolios backed by diverse luxury and alternative assets.
Automated credit decisioning systems adjusting terms based on real-time risk scores.
Risk managers monitoring portfolio exposures and identifying emerging threats.

### Advantages

Holistic risk assessment across asset classes improves lending accuracy.
Dynamic, real-time updates enable proactive risk management.
Integration with provenance and credit systems enhances data reliability and security.

### Figure Descriptions

FIG. 1: System architecture diagram with modules 102, 104, 106, 108, 116, 118, 120, and 130.

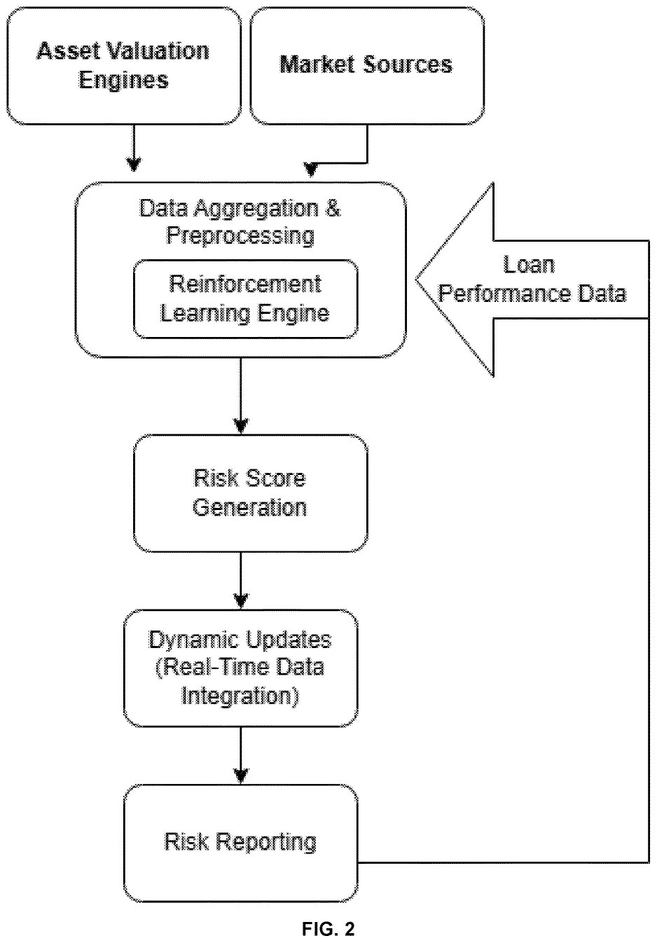

FIG. 2: Workflow diagram of risk assessment and credit line adjustment.

FIG. 3: Credit line adjustment flowchart showing triggers, recalculation, notifications, and blockchain logging.

FIG. 4: Blockchain integration diagram with smart contract interactions.

### FIG. 1: System Architecture

FIG. 1 illustrates the system architecture of the multi-asset class risk assessment system. It shows data ingestion modules collecting AI-generated asset valuations and market indicators. The machine learning engines process these inputs to generate predictive risk scores, including clustering and anomaly detection modules. The risk scoring and reporting components provide actionable insights to lenders. Integration interfaces connect to credit management systems and blockchain-based provenance platforms to ensure data integrity and security.

### FIG. 2—Risk Assessment

FIG. 2 depicts the workflow of the risk assessment process, beginning with data collection from asset valuation engines and market sources. The workflow continues with machine learning modeling, risk score generation, dynamic updates based on real-time data, and risk reporting. The diagram highlights feedback loops where loan performance data informs the reinforcement learning models optimizing risk predictions.

### FIG. 3: Credit Line Adjustment Flowchart Showing Triggers, Recalculation, Notifications, and Blockchain Logging

FIG. 3 is a flowchart illustrating the credit line adjustment algorithm implemented by the system. The flowchart begins with a Start block, followed by a process step where the system receives the latest asset valuation (V) and risk score (R) inputs from the AI Valuation Engine and Risk Scoring Module. Next, the system calculates a new credit line (CL) using the formula CL=max(CL_min, V LTV (1−R)).

A decision block then evaluates whether the credit line has changed beyond a predefined threshold since the last update. If no significant change is detected, the flow proceeds to an End block where the system waits for the next data update. If a significant change is detected, the system triggers notifications to the user or lender via dashboard, email, or mobile alert.

Following notification, another decision block determines if the outstanding balance exceeds the newly calculated credit line. If the outstanding balance is within the credit line, the system logs the credit line adjustment event, including old and new credit line values, timestamp, and reason, and records this event on a blockchain-based provenance platform for audit purposes. The flow then proceeds to the End block awaiting the next update.

If the outstanding balance exceeds the new credit line, the system freezes transactions exceeding the credit line, initiates a margin call if applicable, and notifies relevant parties. Subsequently, the credit line adjustment event is logged and recorded on the blockchain, after which the process ends awaiting further data updates.

This flowchart outlines the dynamic credit line management process incorporating real-time asset valuations, risk assessments, user notifications, transaction controls, and immutable audit logging via blockchain technology.

### FIG. 4: Blockchain Integration Diagram with Smart Contract Interactions

FIG. 4 depicts a blockchain integration architecture for credit line management and audit logging. The Credit Line Module (CLA 130) interfaces with a permissioned blockchain network by invoking smart contract functions. These functions include setCreditLine( ), which records updated credit line values on-chain; freezeAsset( ), which restricts transactions exceeding credit limits; and logAdjustment( ), which writes detailed audit events to the blockchain ledger. The blockchain network further interacts bidirectionally with external systems such as loan management platforms and compliance monitoring tools, supporting secure, immutable recording of credit line events and enforcement of credit policies.

1. A computer-implemented method for multi-asset class risk assessment comprising: a. Receiving, via a network, digital asset data for a plurality of assets, wherein the digital asset data comprises at least one of images, metadata, and provenance documentation; b. Retrieving, via the network, market indicator data corresponding to each asset class from one or more external data sources; c. Aggregating and preprocessing the received asset data and market indicator data to generate normalized asset records; d. Applying one or more machine learning models to the normalized asset records, the one or more machine learning models comprising: i. a clustering algorithm to assign assets to risk tiers; ii. an anomaly detection algorithm to flag outlier assets or transactions; and iii. a reinforcement learning algorithm configured to optimize model parameters based on loan performance data; e. Generating a predictive risk score for each asset or asset bundle based on outputs of the one or more machine learning models; f. Providing, via a user interface or application programming interface (API), risk reports, alerts, and recommendations to a lender or automated credit system; g. Recording key asset events and risk scores on a blockchain-based provenance platform,

2. The method of claim 1, wherein the digital asset data further comprises real-time sensor data from IoT-enabled storage devices.

3. The method of claim 1, wherein the market indicator data comprises at least one of:
volatility indices, liquidity scores, macroeconomic indicators, and sentiment analysis from social or news feeds.

4. The method of claim 1, further comprising normalizing currency values to a common standard and imputing missing data fields using k-nearest-neighbor imputation.

5. The method of claim 1, wherein the clustering algorithm is selected from the group consisting of k-means, DBSCAN, and hierarchical clustering.

6. The method of claim 1, wherein the anomaly detection algorithm comprises at least one of an isolation forest model or an autoencoder-based outlier detector.

7. The method of claim 1, wherein the reinforcement learning algorithm is selected from the group consisting of deep Q-networks, policy gradient methods, and actor-critic algorithms.

8. The method of claim 1, further comprising updating the predictive risk score in real time upon receipt of new asset data or market indicator data.

9. The method of claim 1, wherein the blockchain-based provenance platform comprises a permissioned distributed ledger that stores asset lien records and audit logs.

10. The method of claim 1, further comprising exporting risk reports in at least one of CSV, PDF, or JSON format.

11. The method of claim 1, wherein the user interface comprises a dashboard displaying risk scores with configurable alert thresholds.

12. A system for multi-asset class risk assessment comprising: a. One or more processors; b. Anon-transitory memory storing instructions that, when executed by the one or more processors, cause the system to perform operations comprising: i. Receiving digital asset data and market indicator data via a network; ii. Aggregating and preprocessing said data; iii. Applying machine learning models for clustering, anomaly detection, and reinforcement learning; iv, Generating and updating predictive risk scores; v. Providing risk reports to lenders via a dashboard or API; vi. Recording events on a blockchain-based provenance system.

13. The system of claim 12, wherein the machine learning models are deployed as microservices communicating via RESTful APIS.

14. The system of claim 12, wherein the digital asset data includes at least one of image files, metadata files, and sensor data streams.

15. The system of claim 12, wherein the dashboard comprises interactive visualizations of risk trends and asset histories.

16. The system of claim 12, further comprising an access control module enforcing role-based permissions using OAuth2.

17. The system of claim 12, wherein the blockchain-based provenance system is implemented using Ethereum or Hyperledger Fabric.

18. A non-transitory computer-readable medium storing instructions that, when executed by a computer, cause the computer to: a. Receive asset and market data; b. Preprocess and normalize said data; c. Apply machine learning models as described in claim 1; d. Generate predictive risk scores; e, Output risk reports and record audit data on a distributed ledger.

19. The computer-readable medium of claim 18, wherein the instructions further cause the computer to update risk scores dynamically as new data is received.

20. A computer-implemented apparatus comprising: a. An asset data ingestion interface; b. A market data retrieval interface; c. A machine learning module including clustering, anomaly detection, and reinforcement learning submodules; d. A risk scoring module; e. A reporting and alerting module; f. An integration interface for blockchain provenance recording.

21. The apparatus of claim 20, wherein the asset data ingestion interface is configured to receive data via a mobile application, web portal, or IoT device feed.

22. The apparatus of claim 20, wherein the reporting and alerting module is further configured to trigger automated credit line adjustments based on risk score changes.

23. The apparatus of claim 20, wherein the integration interface supports smart contract execution for lien creation and release, Specialized Claims for Credit Line Adjustment Algorithms

24. The method of claim 1, further comprising:

25. Calculating an initial credit line for a user based on a verified asset value, a predefined loan-to-value ratio, and a normalized risk score;

26. Adjusting the available credit line in real time as at least one of the asset value or risk score changes,

27. The method of claim 24, wherein adjusting the credit line comprises reducing the available line if the asset value decreases by more than a predefined threshold.

28. The method of claim 24, wherein the credit line adjustment is triggered by detection of an anomaly in asset behavior or market conditions.

29. The method of claim 24, wherein the system enforces a minimum allowable credit line and automatically freezes transactions exceeding the adjusted credit line.

30. The method of claim 24, further comprising employing a reinforcement learning algorithm to optimize the loan-to-value ratio and risk score weightings for credit line calculations based on historical loan performance data.

31. The system of claim 12, further comprising a credit line adjustment module configured to:

32. Monitor real-time asset valuations and risk scores;

33. Recalculate available credit using the formula: CL=VLTV (1−R);

34. Initiate user notifications and transaction freezes upon credit line reduction events.

35. The system of claim 29, wherein every credit line adjustment event is recorded to a blockchain platform for compliance and audit purposes.

36. The apparatus of claim 20, wherein the credit line adjustment module is further configured to permit manual override by a user or lender, subject to pre-set policy constraints.

37. The apparatus of claim 20, wherein the credit line adjustment module integrates with smart contracts to enforce credit limits on-chain.

38. A non-transitory computer-readable medium storing instructions that, when executed by a computer, cause the computer to:

39. Calculate and adjust a credit line based on real-time asset values and risk scores;

40. Trigger automated actions including user notification, transaction freezing, and audit logging when credit line adjustments occur.
